(19) United States
(12) Patent Application Publication
(10) Pub. No.: US 2015/0239140 A1
(43) Pub. Date: Aug. 27, 2015

(54) APPARATUS AND METHOD FOR CUTTING FORMABLE AND/OR COLLAPSIBLE MATERIALS

(71) Applicant: DOW GLOBAL TECHNOLOGIES LLC, Midland, MI (US)

(72) Inventors: Mark J. Majestic, Midland, MI (US); James R. Ogle, Sanford, MI (US); Paul J. Sacchetti, Warrington, PA (US)

(21) Appl. No.: 14/427,435

(22) PCT Filed: Mar. 5, 2013
(86) PCT No.: PCT/US2013/029089

§ 371 Date: Mar. 11, 2015

Related U.S. Application Data
(60) Provisional application No. 61/716,124, filed on Oct. 19, 2012.

(51) Int. Cl. B26D 7/08; C04B 41/91; B26D 9/00; C04B 35/622; B26D 3/08; B26D 1/547

(52) U.S. Cl. CPC B26D 7/086; B26D 3/08; B26D 1/547; B26D 9/00; C04B 35/622; C04B 41/91; C04B 2235/6021; C04B 2235/612

(57) ABSTRACT

Extrudate 10 materials that are in a formable and/or collapsible state present multiple challenges for cutting into lengths, particularly when the extrusion profile Includes one or more openings 12 (e.g., running the length of the extrudate 10). The invention is directed at apparatus, devices, systems and methods for cutting the extrudate 10. A cut 64 (e.g., and initial cut) into the extrudate 10 is performed using an ultrasonic knife 27 that vibrates at one or more frequencies. Preferably the cut using the ultrasonic knife 27 is a partial cut 64. A further cut through the extrudate 10 may be made using a secondary cutting tool such as a wire cutter 68. The secondary cutting tool preferably creates a final cut 66 through the extrudate profile, for cutting a part to a length. The ultrasonic knife 27 preferably travels In the horizontal direction at a rate faster than the extrudate 10 while cutting.

### CLAIM OF PRIORITY

The present application claims the benefit of U.S. Provisional Patent Application 61/716,124 filed on Oct. 19, 2012, which is incorporated herein by reference in its entirety for all purposes.

### FIELD OF THE INVENTION

The present invention relates to devices, apparatus, systems, and methods of cutting a material, such as an extrudate material. In particular, the invention relates to cutting an extrudate material that is formable, collapsible, or both.

### BACKGROUND OF THE INVENTION

When extruding a material there is often a need to cut the extruded profile into lengths of the profile. During the extrusion of the material, the material generally passes through a die in an easily formable state. As used herein, an easily formable state is a liquid state, melt state, moldable clay state, or other dough-like state capable of flowing under an applied shear force, capable of being extruded, or both. After exiting the extruder, the material is generally cooled or otherwise solidified prior to cutting.

In some cases, such as when extruding a generally solid profile (i.e., a profile with no cells running the length of the profile), the extrudate may be cut while still in a formable state. For example, polymer pellets may be cut from a solid extrudate profile using an underwater pelletizer where the material is cut using a blade that touches the die face or is within a few mm of the die face. Here, the shape of the profile is deformed by cutting blade. In other cases, the solid profile may be slowly cut using a cutting blade or cutting wire where the lack of cells provides support for minimizing the deformation of the profile.

However, when extruding a non-solid profile having one or more cells (i.e., openings running the length of the extrudate), the ability to cut the extrudate while in a formable state is constrained by the possibility of sealing a cell while cutting the extrudate. Here it is important that the cells remain open so that air may flow from an open end of the extrudate to the die where a continuous supply of air is required for maintaining the cell structure as the material advances through the extruder die. If a cell becomes sealed, a vacuum will be created within the cell and some or all of the extrudate may collapse.

This problem of collapse of an extrudate is magnified when the profile includes a large number of cells, when a wall around a cell is thin, when the profile has intricate design, when the profile has tight dimensional tolerances, or any combination thereof.

There exists a need for improved cutting devices, apparatuses, systems, and methods for cutting materials that are formable, collapsible, or both. For example, there is a need for cutting devices, systems, apparatuses and methods for cutting parts made from inorganic compounds (e.g., ceramic compounds) in a wet formable state (e.g., after being extruded and prior to any drying step or baking steps). In particular, there is a need for devices, apparatuses and methods for cutting an extruded profile having multiple rows of elongated cells running the length of the part without collapsing the cells.

There is also a need for cutting devices, apparatuses, systems, and methods that do not deform the part during cutting, that use reduced cutting force, or both. Additionally, there is a need for a method for cleaning cutting tools that are used in cutting extrudates that include inorganic compounds.

### SUMMARY OF THE INVENTION

One or more of the above needs are met by the teachings herein.

One aspect of the invention is directed to an apparatus for cutting an extrudate comprising an ultrasonic knife that vibrates at one or more frequencies for making one or more precuts into an extrudate; and one or more wire cutters for making a final cut into the extrudate; so that an extruded part having a predetermined length may be cut from the extrudate.

Another aspect of the invention is directed at a process for cutting an extrudate comprising a step of precutting the extrudate using an ultrasonic knife, wherein the extrudate includes, consists essentially of, or consists entirely of one or more inorganic compounds.

Another aspect of the invention is directed at a process for cutting an extrudated using an apparatus according to the teachings herein, wherein the process comprises a step of precutting the extrudate using the an ultrasonic knife, and finishing the ecut using a wire cutter.

### BRIEF DESCRIPTION OF DRAWINGS

FIG. 1 is a cross-sectional view of an illustrative extrudate having one or more openings.

FIG. 2A is a drawing of a portion of an illustrative blade end of an ultrasonic knife according to the teachings herein.

FIG. 2B is a cross-sectional view of an illustrative blade tip according to the teachings herein.

FIG. 2C is a cross-sectional view of another blade tip.

FIG. 3 is a drawing of a section of an illustrative blade having a tapered end.

FIG. 4A is a schematic drawing of an illustrative extrudate during a pre-cut process according to the teachings herein.

FIG. 4B is a drawing of an illustrative extrudate following a pre-cut according to the teachings herein.

FIG. 5 is a drawing of an illustrative extrudate wire inserted into the space of a pre-cut.

FIG. 6 is a drawing of an illustrative extrudate with a wire cutter having made a final cut through the cross-section.

FIG. 7 is a drawing of an illustrative extrudate with a wire cutting being removed from the extrudate.

FIG. 8 is a drawing of an illustrative extrudate having a honeycomb structure with a plurality of cells extending the length of the extrudate.

FIG. 9 is a drawing of an illustrative extrudate having an array of cells extending the length of the extrudate.

FIG. 10 is a schematic of a cutting system including features according to the teachings herein.

### DETAILED DESCRIPTION

The explanations and illustrations presented herein are intended to acquaint others skilled in the art with the invention, its principles, and its practical application. The specific embodiments of the present invention as set forth are not intended as being exhaustive or limiting of the invention. The scope of the invention should be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description. One or more as used herein means that at least one, or more than one, of the recited components may be used as disclosed.

### Definitions

As used herein, a formable state (e.g., an easily formable state) is a liquid state, melt state, moldable clay state, or other dough-like state capable of flowing under an applied shear force, capable of doing extruded, or both. If the material is in a liquid state, the zero shear viscosity (i.e., the viscosity obtained by extrapolation of the shear rate versus viscosity curve to a shear rate of zero) preferably is sufficiently high so that a formed part is capable of generally maintaining its shape between the time of forming and the time the material is no longer in a formable state. While in a formable state, the material preferably is extrudable (i.e., capable of being formed into a shape using an extrusion process).

This aspect of the invention may be characterized by one or any combination of the following features: the ultrasonic knife has a blade with a tapered tip; the apparatus includes a water bath for ultrasonically cleaning the knife; the extrudate has a plurality of cells including a first row of cells near the bottom of the extrudate and a top row of cells near the top of the extrudate; the apparatus includes an extruder for extruding the extrudate; the apparatus includes a die for forming a profile for the extrudate; the apparatus includes a conveyor for conveying the extrudate away from the die in the horizontal direction; the ultrasonic knife is capable of traveling in the horizontal direction generally synchronously with the conveyor while making the precut; the ultrasonic knife has a vibration frequency of about 13 kHz or more (e.g., about 20 kHz or more); the ultrasonic knife has a surface that includes titanium, the wire cutter has a diameter of about 0.5 mm or less (e.g., about 0.3 mm or less, or about 0.2 mm or less); the apparatus includes a die capable of producing a profile having 3 or more rows of cells (e.g., five or more rows of cells); or the die is selected so that cross-section of the extrudate profile (i.e., perpendicular to the extrusion direction) has a profile cross-sectional area and cross-section of the extrudate profile has cells having a total cell cross-sectional (e.g., where the ratio of the total cell cross-sectional area to the profile cross-sectional area is about 0.4 or more).

Any process for cutting an extrudate may be further characterized by one or any combination of the following features: the process includes a step of cutting the extrudate with a wire cutter; the process includes a step of cutting the extrudate with a wire cutter so that an extruded part having a predetermined length is formed; the extrudate has a plurality of rows of open cells including an uppermost row of open cells, and a top outer wall above the uppermost row of open cells, wherein the precut cuts through the top outer wall; the extrudate includes, silicon atoms, aluminum atoms, or both; the process includes a step of extruding a mixture including one or more inorganic compounds through an extruder; the process includes a step of forming a profile by passing the mixture through a die; the process includes a step of conveying the extrudate away from the die using a conveyor in the extrusion direction; the step of precutting the extrudate includes synchronously moving the ultrasonic knife and the extrudate in the extrusion direction while cutting the extrudate by moving the ultrasonic knife in a direction perpendicular to the extrusion direction; the process includes a step of removing inorganic material from a surface of the knife by moving the knife to a water bath and vibrating the knife in the water; the extrudate includes clay; the extrudate has three or more rows of open cells including an uppermost row of open cells and a top outer wall above the uppermost row of open cells, wherein the step-of precutting the extrudate includes cutting entirely through the top outer wall so that the uppermost row of open cells is exposed; the ultrasonic knife has a frequency of about 15 kHz or more; the wire cutter travels and the extrudated travel synchronously during the step of final cutting of the extrudate with the wire cutter, and the wire cutter has a diameter of about 0.5 mm or less; the ultrasonic knife includes a blade having a tapered tip for cutting; the process includes a step of removing the ultrasonic knife from the extrudate, wherein the ultrasonic knife travels faster in the extrusion direction relative to the extrudate so that only the front of the knife contacts the extrudate while removing the ultrasonic knife from the extrudate; the extrudate has a generally rectangular profile with a width and height and the blade has a cutting edge having a length that is greater than the length of the width of the profile; one or more of (e.g., all of) the cells of the part remain open after cutting the profile; one or more of (e.g., all of) the cells of the extrudate trailing the part remain open after cutting the profile; about 35% or more of the atoms in the profile are oxygen atoms; or any combinations thereof.

The apparatus includes an ultrasonic knife for suitable making one or more precuts into a formable mass. The apparatus is particularly useful for making a precut such as an initial cut, info a formed mass when the material is still in a formable state (i.e., a formable mass) so that features of the cross-section are generally maintained. For example, the apparatus may be employed in cutting a formable mass that is an extrudate. The extrudate may have a generally uniform cross-section. Typically, the cross-section is partially or entirely defined by a die through which the material flows. As used herein, a precut is a cut through at least a portion of the cross-section of the extrudate. Generally, the precut does not completely cut through and divide (i.e., separate) the extrudate, so that one or more additional separation cuts are required to divide the extrudate. For example, a separation cut may extend a precut through a further portion and/or the remainder of the cross-section. The precut may be used as a guide or locator for one or more separation cuts that result in a workpiece having a predetermined length in the extrusion direction. By separating the workpiece from another portion of the extrudate, it may be possible to perform one or more operations to the workpiece. For example, it may be possible to move or convey a workplace, expose the workpiece to a different environmental condition (compared with the environmental condition of the initially formed extrudate) such as a different temperature and/or different humidity environment, stack or otherwise arrange a plurality of workplaces, of any combination thereof. It will be appreciated that the precut and the separation cut(s) may result in a workpiece with a desired length for an application or that the workpiece may later be subjected to additional cutting steps, lengthwise or otherwise that result in a desired length or shape.

The ultrasonic knife preferably is selected for making a precut in a material that is formable and collapsible. The ultrasonic knife finds particular benefit in cutting extrudates having one or more openings extending the length of the extrudate, without plugging or otherwise closing the opening. It will be appreciated that when an opening is closed or plugged on the extruder side of the workplace, the extruded shape will no longer be maintained as air will not able to enter the new lengths of the opening being created at the die. A vacuum may thus be formed which results in the extrudate collapsing. As such, it may be particularly advantageous to have a device, system, or method for cutting the extrudate so that none of the openings in the cross-section on the extruder side (i.e., the upstream side) of the cut becomes closed or otherwise plugged.

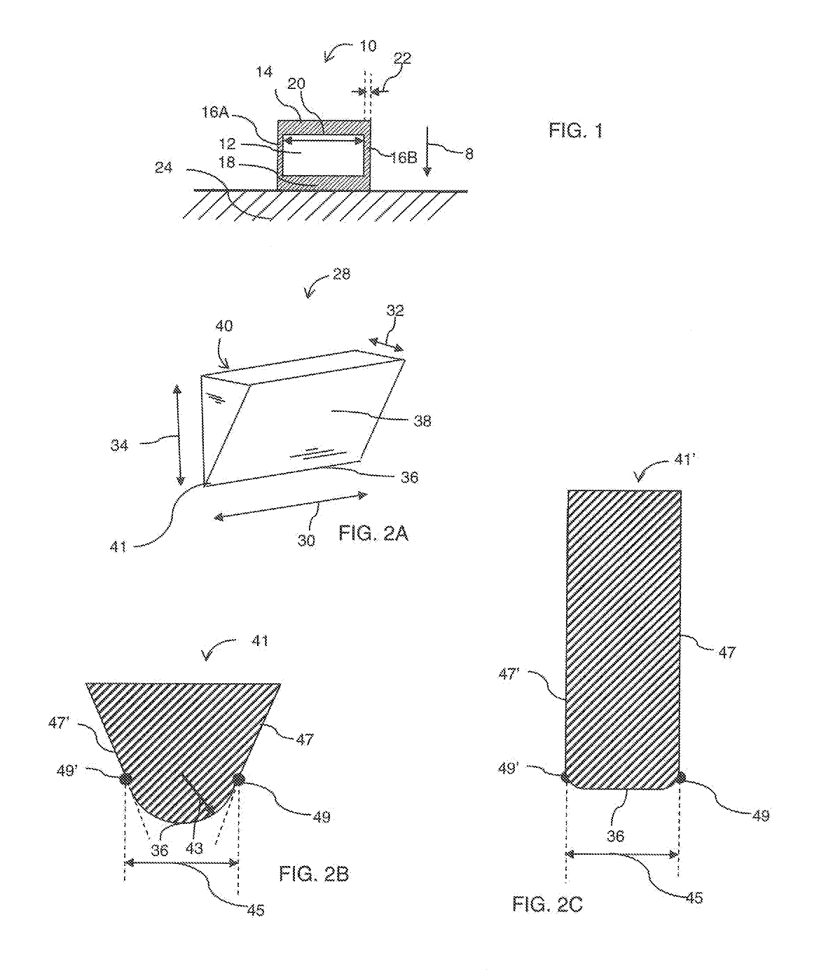

In cutting the extrudate, the first cut through an opening is typically the most difficult. For example, when cutting through a wall surrounding an opening that is also an outside wall, the structure of the extrudate may provide limited or even no support for the structure in the outer direction. Here, the forces in the cutting direction (e.g., the direction of the thickness of the outside wall being cut) may cause the outside wall to deformed, may cause one or more walls supporting the outside wall to buckle or fold, or both. FIG. 1 is an illustrative drawing of a cross-section of an extrudate 10 in the transverse direction showing features of an extrudate that may be cut according to the teachings herein. The extrudate 10 may be supported by a substrate 24, such as a conveyor belt. The extrudate may have an opening 12 and a plurality of walls, 14, 16A, 16B, and 18, that surround the opening 12. The direction of cutting 8 may be in the thickness direction of one of the walls, such as an outer wall 14. The initial outer wall 14 to be cut may be supported by one or more walls support walls 16A, 16B. The width 20 of the outer wall 14 that is initially cut may be generally large, the thickness 22 of a support wall may be generally low, or both, so that care must be taken to prevent collapse of the opening during the cutting of the outer wall 14.

The difficulty of making a cut through an extrudate generally increases when the extrudate has a plurality of openings (e.g., extending the length of the extrudate), when the wall thickness of a support wall is small, when the width of the opening (e.g., in the direction perpendicular to the cutting direction) is large or any combination thereof.

In addition to the shape of the profile being cut, the level of difficulty of cutting an extrudate may be increased when cutting materials that are in a state capable of being permanently deformed with the application of a low force. For example, materials that are in a thixotropic state can generally maintain a shape when no force is applied, but will flow when a low force is applied. Examples of materials that may be thixotropic include high molecular weight polymers heated to a temperature above their glass transition temperature and above any melting temperature so that they can flow. Other examples of materials that may be thixotropic include mixtures comprising high concentrations of particles with one or more liquids. Such material include clays suitable for molding or extruding, dough-like materials, mixtures of particles with water or a binder, and the like.

The ultrasonic knife preferably is a knife that vibrates at one or more frequencies for making a precut into the extrudate. The ultrasonic knife generally includes a blade with one or more cutting surfaces that contacts the material being cut.

FIG. 2A illustrates a blade end 28 having features suitable for an ultrasonic knife according to the teachings herein. The knife blade and may have one or more cutting edges 36. The cutting blade may have a toward side (i.e., a leading side) 38 and a rearward side (i.e., a trailing side) 40. The forward side may generally face toward the downstream direction of an extrudate and the rearward side may generally face toward the upstream direction of an extrudate (e.g., towards the direction of the extrusion equipment). The blade end 28 may be tapered so that the tip 41 of the blade is sufficiently thin for making an initial cut without collapsing a cell in the material being cut. For example, the tip 41 may be characterized, as having a thickness, a radius or both that is about 1500 μm or less, preferably about 700 μm or less, more preferably about 500 μm or less, even more preferably about 300 μm or less, even more preferably about 200 μm or loss, and most preferably about 100 μm or less. FIGS. 2B and 2C are cross-sectional views of blade tips 41, 41′. With reference to FIG. 2B, the blade tip may be characterized by a radius 43. With reference to FIGS. 2B and 2C, the blade may have a forward side having a generally planar region 47 and/or a rearward side having a generally planar region 47′. The cross-section of the blade tip 41 may have a forward transition point 49 and a rearward transition point 49′ at which the forward and rearward sides are no longer planar. The thickness of the blade tip 45 may be measured by the separation of the two transition points 49, 49′ as illustrated in FIGS. 2B and 2C. The blade tip 41 should have a sufficient thickness, radius, or both, so that the blade is durable (e.g., does not break, bend, or nick), during cutting operations. Such durability may be particularly critical when cutting materials including a concentration of inorganic particles of about 30 wt. % or more, about 50 wt. % or more, about 70 wt. % or more, or about 85 wt. % or more. For example, the blade tip may be characterized by a radius, thickness, or both that is preferably about 3 μm or more, more preferably about 10 μm or more, even more preferably about 20 μm or more, even more preferably about 30 μm or more, and most preferably about 40 μm or more.

The vibration of the knife may include a longitudinal vibration 30 (i.e., in the direction parallel to the length of the cutting edge 36), a penetrating vibration 34 (i.e., in the cutting direction), a transverse vibration 32 (i.e., in the direction between two surfaces being created by the cut). Preferably, the vibration of the knife includes, consists essentially of, or consists entirely of a transverse vibration 32.

The device generally includes one or more transducers capable of causing the ultrasonic vibration. The transducer may produce vibrations in the ultrasonic frequency. For example, the transducer may produce vibrations at a frequency of about 5 kHz or more, about 13 kHz or more, about 15 kHz or more, about 20 kHz or more, about 30 kHz or more, about 35 kHz or more, or about 40 kHz or more. The transducer typically preferably produces vibrations at a frequency of about 400 kHz or less, more preferably about 100 kHz or less. However, transducers that produce higher frequency vibrations may also be used. The transducer may produce vibrations using any process. Transducers that use a piezoelectric electric element are most preferred.

The transducer should produce a vibration having a sufficiently high amplitude so that the material being cut is pushed away and only touches the blade surface for short periods of time. The amplitude of the vibration preferably is about 1 μm or more, more preferably about 3 μm or more, and most preferably about 10 μm or more. The transducer should produce a vibration having amplitude that is sufficiently low so that openings of the extruded profile are not closed. For example, the amplitude preferably is about 800 μm or less, more preferably about 300 μm or less, even more preferably about 100 μm or less, and most preferably about 70 μm or less.

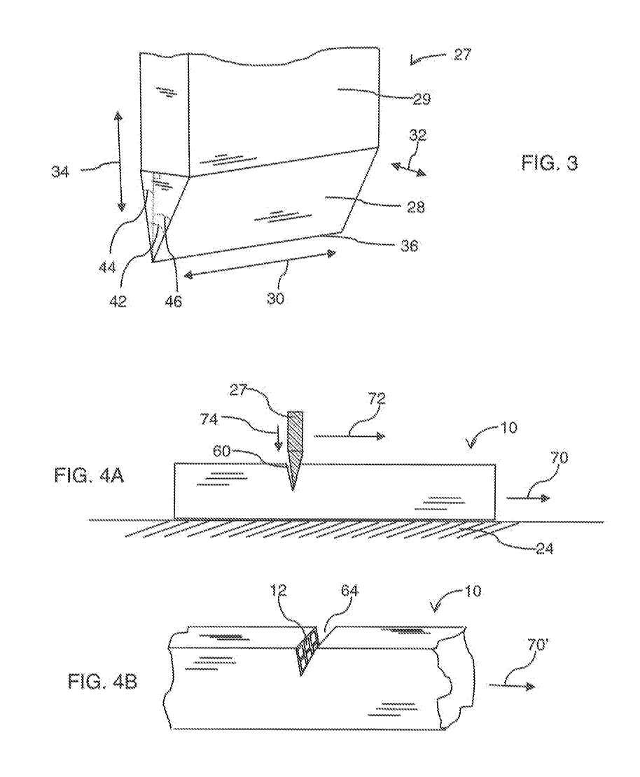

FIG. 3 illustrates a cutting blade 27 having features that may be used in an ultrasonic knife according to the teachings herein. The cutting blade may include a blade end 28 and a blade base 29. The blade end may project from the blade base. Preferably, the blade is a monolithic structure. For example, the blade base and the blade end may be made of the same material. One or more surfaces of the blade base, the blade end, or both may have a coating. For example, one or more surfaces may have a coating for improving the durability of the surface. The coating may be a metal coating, a polymer coating, or a nonmetal inorganic coating. Other surface treatments that may improve the durability of the surface of a metal may also be employed. For example, techniques that implant one or more atoms at or near the surface of the metal may be employed. The durability of the blade or blade surface may be characterized by one or any combination of the following: resistance to corrosion in a humid environment, resistance to corrosion in a basic environment, resistance to corrosion in an acidic environment, strength of the material of the blade, scratch resistance of the surface, and hardness of the surface. If will be appreciated that blades that have a surface, e.g., a cutting surface that is free of a coating may also be employed. This may be particularly advantageous when there may be a need to sharpen a blade or material below the surface of the blade otherwise becomes exposed. Here, blades that are monolithic with a cutting surface that is not coated may be particularly advantageous.

The blade may be made of any suitable material for cutting. Such materials include metals, polymers, ceramics, and glasses. When cutting a material that includes water, it may be desirable for the blade to be resistant to corrosion in a humid or wet environment. Preferably, the blade includes, consists essentially of, or consists entirely of one or more metals or metal alloys. For example, the blade may be formed of a metallic material that includes at least 51 atomic percent of one or a combination of the following elements: iron atoms, aluminum atoms, titanium atoms, tungsten atoms, zinc atoms, or copper atoms. Preferred metals for use in humid environments include titanium metal, titanium alloys, stainless steel or a combination thereof.

The blade base 29 may have a generally forward facing surface and a generally rearward facing surface. The generally forward facing surface may face downstream of the material being cut. The generally rearward facing surface may face upstream, such as in the direction of the extrusion equipment. The generally forward facing surface and the generally rearward facing surface preferably have an angle of about 5° or less, and more preferably are parallel (i.e., an angle of 0°).

The blade end may be tapered so that the distance between the forward facing surface and the rearward facing surface decreases towards the tip of the blade. The taper angle of the blade is the acute angle formed by the toward facing surface and the rearward facing surface of the blade end. The taper angle may be about 0.5° or more, about 2° or more, or about 5° or more. The taper angle may be about 60° or less, about 40° or less, about 30° or less, or about 20° or less.

The taper angle of the blade end typically includes a leading taper angle and a trailing taper angle. The leading taper angel is the acute angle between the forward face of the blade end and the cutting direction. The trailing taper angle is the acute angle between the rearward face of the blade end and the cutting direction. The taper angle may be defined as the sum of the leading taper angle and the trailing taper angle. The trailing taper angle should be sufficiently small so that material displaced during the cutting does not seal a cell or otherwise impede the flow of air into a cell. The trailing taper angle may be about 0° or more, about 0.5° or more, about 1° or more, about 1.5° or more, or about 2° or more. Preferably the trailing taper angle is about 10° or less, more preferably about 8° or less, even more preferably about 6° or less, even more preferably about 5° or less, even more preferably about 4° or less, and most preferably about 3° or less. The leading taper angle preferably is greater in magnitude than the trailing taper angle. For example, the ratio of the leading taper angle to the trailing taper angle may be about 1.1 or more, about 1.5 or more, about 2 or more, about 3 or more, about 5 or more, about 7 or more, about 10 or more, or about 20 or more. The leading taper angle may be less than the trailing taper angle when the blade is used in a process where the blade is moving in the downstream direction at a sufficiently faster rate compared with any motion of the workpiece being cut, so that cells are not filled with material displaced by the cutting process. As illustrated in FIG. 3, the blade end 28 may include a taper angle 42 that consists of a leading taper angle 46 and a trailing taper angle 44. Preferably, the sum of the leading taper angle 46 and the trailing taper angle 44 equals the taper angle 42.

Some or all of the pre-cut may be made using the end of the blade. For example, the pre-cut may be characterized by only the surfaces of the tapered portion of the blade contacting the workpiece. It will be appreciated that the process may avoid having the blade base contact the workpiece. As such, blades that are free of a blade base 20 may be employed. A blade base 29, if employee, preferably has a leading taper angle less than the leading taper angle 46 of the blade end 28, and more preferably the blade base 29 has a leading taper angle of about 0°. A blade base 29, if employed, preferably has a trailing taper angle that is less than the trailing taper angle 44 of the blade end 28, and more preferably the blade base 29 has a trailing taper angle of about 0°.

Because the pre-cut is generally a shallow cut, the process may use relatively short blades. For example, the ratio of the height of the blade (i.e., in the direction of the out) to the height of the workpiece (i.e., in the direction of the cut) may be about 0.95 or less, about 0.8 or less, about 0.6 or less or about 0.4 or less. The blade should have a height sufficient for making the precut. For example, the ratio of the height of the blade to the height of the workpiece may be about 0.01 or more, or about 0.1 or more. It will be appreciated that blades having heights that are greater than the workpiece may also be employed.

The apparatus may include one or more vibration controller for controlling the vibrations of the ultrasonic knife. The controller may control one or any combination of the following: the amplitude of the vibrations, the frequency of the vibrations, the duration of the vibrations, the start of the vibrations, or the cessation of vibrations. The controller may be used to start or increase the ultrasonic vibrations (e.g., to a predetermined frequency, to a predetermined amplitude, or both) for a cutting step. The controller may be used to stop or reduce the ultrasonic vibrations following a cutting step. For example, while the blade is descending into the material being cut, the blade may vibrate, and at one or more times when the blade is not descending into the material being cut, the blade may not vibrate. The controller may be used in a step of starting or increasing the ultrasonic vibrations (e.g., to a predetermined frequency, to a predetermined amplitude, or both) for cleaning the blade in a bath with a cleaning fluid. It will be appreciated that the apparatus may be free of a vibration controller. For example, the ultrasonic knife may vibrate continuously.

The apparatus includes a movable knife support capable of moving the ultrasonic knife in one or more directions. The knife support may move the knife in the cutting direction so that the workplace is cut. The knife support may move the knife away from the cutting direction so that the knife retracts from the workpiece. According to the teachings herein, the workplace may be in motion during the cutting process, i.e., the workpiece may be moving in a traveling direction. For example, the workpiece may be an extruded material fresh from the die of an extruder where the travel direction is the extrusion direction. The knife support may move the ultrasonic knife in the travel direction while making a cut (e.g., a pre-cut) into the workpiece. While making a cut in the workpiece, the ultrasonic knife may move in the travel direction at the same speed, at a lower speed, or at a higher speed relative to the workpiece; preferably at the same speed or at a higher speed relative to the workpiece; and most preferably at a higher speed relative to the workpiece. For example, the ultrasonic knife may move in the travel direction at a sufficient speed so that the trailing surface of the blade does not contact the workpiece, so that cells of the workpiece in the upstream direction are not closed, or both. As such, the knife support may simultaneously move the knife in the cut direction and in the travel direction. Preferably the knife support is capable of controlling the direction of motion of the knife in at least the cutting direction and in the travel direction. After making a pre-out, the knife support may move the ultrasonic knife in the direction opposite the cutting direction for retracting the knife from the workpiece. The knife support may be capable of moving the knife to a cleaning device, such as discussed hereinafter, moving the knife to a position for making another cut (such as a starting position for making another pre-cut), or both.

The movable knife support device may be any known device suitable for moving the knife in the directions necessary to cut the extrudate. The movable knife support may be capable of identifying the location of the part to be cut. The movable knife support may be capable of from 1 to 6 axis of movement per station. Devices with only one axis of movement require that the extrudate be moved into place for stationary cutting. As the extrudate is generally moving axially away from the extruder die, it is preferred that the device is capable of t or more axis of movement. Devices capable of greater than 2 axis of movement may allow the cutter (e.g., the ultrasonic knife) to move between positions for other cutting processes, for a cleaning process, or both. Exemplary devices include robots, pneumatically-actuated 2-d slides, linear motion systems, rotary motion systems, and the like. The device may be pneumatic, hydraulic and electromechanical driven motion systems.

The apparatus may include one or more controllers for controlling the position of the ultrasonic knife. For example, the controller may control the position of the ultrasonic knife relative to a moving workpiece. The controller may include one or more activators or sensors for determining when a pre-cut step is needed, one or more activators or sensors for determining when a pre-cut step is completed, one or more activators or sensors for determining when a blade needs cleaning, one or more activators or sensors for determining the rate of travel of a workpiece, or any combination thereof. The controller may include a sufficient numbers of sensors so that the workpiece material (e.g., the extrudate) is cut to a predetermined length.

The apparatus may include one or more conveyors for conveying the material (e.g., the extrudate) in a travel direction. The conveyor may be controlled so that the extrudate has a predetermined cross-section. For example the apparatus may have an extrudate conveyor positioned near the exit of a die for receiving the material being extruded. The extrudate may move uniformly with the rate of the material being extruded, or may have a higher rate so that the material is drawn down to a desired level.

The system may include an extruder, an extruder die, an extrudate conveyor, a secondary conveyor downstream of an extrudate conveyor, a drying device, a sensor for measuring one or more dimensions of the extrudate, or any combination thereof. The system may include an extruder for extruding the extrudate. The system may include a die for forming a profile for the extrudate. The system may include an extrudate conveyor for conveying the extrudate away from the die in the horizontal direction.

The apparatus preferably includes a die for forming a part having a generally continuous profile including one or more elongated cells. For example the die may produce a profile characterized by one or any combination of the following: the profile includes one or more rows of cells, the profile includes one or more columns of cells, the profile includes an array of elongated cells, the profile includes a honeycomb arrangement of cells, or the profile includes four or more cells. Preferably the die is capable of producing a profile having an array of elongated cells. For example the die may be capable of producing a profile having 3 or more rows of cells (e.g., five or more rows of cells). The die may be selected so that the cross-section of the extrudate profile (i.e., perpendicular to the extrusion direction) has a profile cross-sectional area and the cross-section of the extrudate profile has cells having a total cell cross-sectional area, wherein the ratio of the total cell cross-sectional area to the profile cross-sectional area is about 0.4 or more.

The extruder may extrude a material at a temperature near ambient temperature (i.e., from about −5° C. to about 38° C.) or at an elevated temperature (i.e., above 38° C.). For example, the temperature of the extruded material as it leaves the extruder and/or as if is cut may be about −5° C. or more, about 0° C. or more, about 5° C. or more, about 10° C. or more, about 15° C. or more, about 20° C. or more, about 25° C. or more, or about 38° C. or more. The temperature of the extruded material as it leaves the extruder and/or as it is cut may be about 100° C. or less, about 70° C. or less, about 50° C. or less, about 40° C. or less, about 38° C. or less, about 35° C. or less, or about 30° C. or less. In a preferred process, the extruded material includes greater than 60 wt. % inorganic particles and is extruded near ambient conditions.

The blade of the ultrasonic knife may require cleaning to remove material that becomes deposited on the surface. The cleaning of the blade may include a step of spraying a cleaning liquid onto one or more surfaces of the blade, spraying a gas onto one or more surfaces of the blade, placing the blade info a bath including a liquid, ultrasonically cleaning the blade by activating the transducer of the knife while the blade is contacting liquid, or any combination thereof. Preferably, the cleaning of the blade includes: a step of placing the blade in a bath of a cleaning liquid, a step of vibrating the blade, and a step of removing the blade from the bath. The cleaning liquid may be any liquid suitable for use in a spray or an ultrasonic bath. For example, the cleaning liquid may include, consist essentially of, or consist entirely of water, one or more solvents, one or more surfactants, or any combination thereof. Cleaning of the blades may be done while the blade or knife is attached to a mechanical movement device, or when the blade or knife is removed from a mechanical movement device. For example a mechanical movement device may be employed for both a cutting step and a cleaning step where the knife is moved from between a first cutting position to a second cleaning position. Alternatively, or in addition a mechanical movement device, such as a robotic arm or other mechanical device, may be employed to move a cleaning bath or spray nozzle to the knife. Cleaning of the blade may occur at any desired interval between steps of cutting workplaces. For example, the cutting blade may be cleaned after a predetermined interval of pre-cuts (e.g., after every cut, after every other cut, after every nth cut), or at irregular intervals based on determination of an operator and/or based on determination by an automated inspection.

As discussed above, the apparatus may include one or more components for cleaning the blade of the ultrasonic knife. For example, the apparatus may include a spray gun, a spray nozzle, a bath for holding a cleaning liquid, a device for automatically moving an ultrasonic knife to cleaning equipment, a device for automatically moving cleaning equipment to an ultrasonic knife, a fluid connection for supplying a cleaning fluid to a spray gun or cleaning bath, or any combination thereof.

With reference to FIGS. 4A and 4B, an extrudate 10 may be cut using a cutting blade 27 while the extrudate is advancing. FIG. 4A is a side view cross-section showing illustrative features of a cutting process and FIG. 4B is a schematic view showing a portion of an extrudate after a cut using an ultrasonic blade is made. The extrudate 10 may be on a substrate 24, such as a conveyor belt, that is advancing. Preferably the cutting blade 27 advances in the same direction as the extrudate 10 in addition to advancing into the extrudate. As such, the motion of the cutting blade may include a cutting blade horizontal rate 72 and a cutting blade vertical rate 74. The motion of the extrudate may be characterized by an extrudate advancing rate 70, which is preferably in a horizontal direction. Preferably the cutting blade horizontal rate is in the same direction as the extrudate advancing rate. Preferably, the cutting blade horizontal rate is greater than the extrudate advancing rate. As such, the trailing surface of the cutting blade may move away from the freshly cut extrudate so that contact between the trailing surface and the extrudate is reduced or eliminated. Preferably, during the cutting process there is a gap 60 between the trailing surface of the cutting blade and the extrudate. The gap 60 preferably is sufficiently large so that air can flow into any of the openings 12 that have been pierced by the cutting blade (e.g., during a precutting step). As such, any vacuum in the openings upstream of the cutting blade may be reduced or eliminated. The cutting blade vertical rate 74 is preferably selected for efficient cutting of the extrudate without blocking the openings 12 during the cutting process. The initial cut penetrates at least the first layer of openings 12. After the initial cut (e.g., precut) is completed, the cutting blade may be removed by moving the blade upward in the vertical direction. When the blade is removed, the extrudate is left with a gap 64. The gap preferably has a wedge shape, with the widest portion of the gap at the top of the extrudate 10.

The apparatus may include one or more secondary cutting devices for finishing a cut started by an ultrasonic knife. The secondary cutting device preferably is not an ultrasonic knife. For example, the secondary cutting device may employ a cutting tool that is thinner than the ultrasonic knife.

A particularly preferred secondary cutting device is a device that employs a wire for making a finishing cut. The secondary cutting device may be a wire cutter. The wire preferably is sufficiently thin so that it can be inserted into the opening created during a pre-cut without touching the preceding or trailing exposed edges created by the pre-cut. Wire preferably has a thickness or diameter of about 1.0 mm or less, more preferably about 0.5 mm or less, even more preferably about 0.3 mm or less, and most preferably about 0.2 mm or less. The wire should be sufficiently thick so that the wire will not break while being used for cutting. Preferably, the wire should is sufficiently thick so that it can cut parts having a width of about 1 inch or more (e.g., having a width of about 2 inches or more, or about 3 inches or more), so that the wire can cut parts at a cutting rate of about 1 inch/minute or more (e.g., about 2 inches/minute or more, or about 5 inches/minute or more, or about 10 inches/minute or more), or both. For example, the wire may have a thickness or diameter of about 0.013 mm or more, about 0.025 mm or more, about 0.05 mm or more, or about 0.10 mm or more.

The secondary cutting device, such as a wire cutter preferably is capable of traveling synchronously with the extrudate during the cutting process. For example, while the wire is cutting into the extrudate, the wire cutter preferably travels synchronously with the extrudate. Similarly, while the wire is being withdrawn from the extrudate, the wire cutter preferably travels synchronously with the extrudate.

The apparatus may include one or more movable wire cutter supports capable of moving the wire cutter in one or more directions. Suitable wire cutter support may have one or any combinations of the features described herein for the movable knife support. For example, the movable wire cutter support may be capable of moving the wire in the cutting direction (e.g., for making a final cut), moving the wire in away from the cutting direction (e.g., for retracting the wire from the final cut), moving the wire in the travel direction of the extrudate, moving the wire in the reverse travel direction of the extrudate, or any combination thereof.

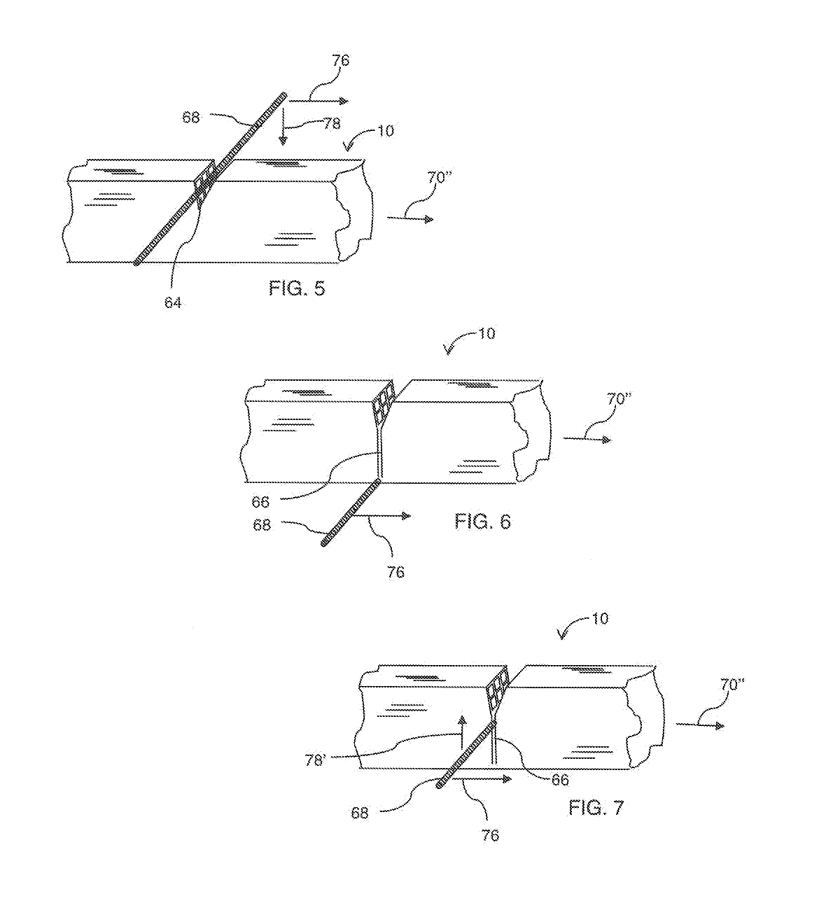

A secondary cutting process may include one or any combinations of the features shown in FIGS. 5, 8, and 7. The secondary cutting process may use a secondary cutting tool, such as a wire cutter 68. The wire cutter 68 may be positioned in a gap 64 formed in an initial cutting step. During the secondary cutting process, the extrudate may be advancing at an extrudate advancing rate 70″ (which may be the same or different as the extrudate advancing rate 70 when performing the initial cut). The wire cutter 68 preferably has motion in the horizontal and vertical directions. The movement of the wire cutter 68 in the vertical direction is the wire cutter vertical advancement rate 78 and the movement of the wire cutter in the horizontal direction is the wire cutter horizontal advancement rate 76. The wire cutter 68 preferably does not move relative to the extrudate 10 in the horizontal direction. As such, the wire cutter horizontal advancement rate 76 preferably is the same as the extrudate advancement rate 70″ while cutting with the wire cutter, while removing the wire-cutter from the cut extrudate, or both. The wire cutter horizontal advancement rate. After cutting some or ail of the extrudate 10 that was not cut in the initial cutting step, the wire cutter 68 stop traveling in the vertical direction as shown in FIG. 6. With reference to FIG. 6, the wire cutter 68 may create a separation 66 between the two sides of the extrudate 10. With reference to FIG. 7, the wire cutter 68 may be removed from the cut extrudate by moving the wire cutter 68 in a upward vertical direction at a wire vertical cutter advancement rate 78′. While removing the wire cutter 68, the horizontal rates 76, 70″ of the extrudate and the wire cutter are preferably the same so that the wire cutter travels generally along the separation 66.

With reference to FIG. 10, the cutting system according to the teachings herein may include an extruder 80, an extruder die 82, an ultrasonic knife having a knife blade 27, a wire cutter 84, a movable knife support 88, a movable wire cutter support 87, an extruder conveyor 88, and a secondary conveyor 90, or any combination thereof. The cutting system may include a secondary cutting tool, such as a wire cutter 68. The cutting system may advance the extrudate 10 (e.g., away from the extruder) at an extrudate advancement rate 70. It will be appreciated that the extrudate advancement rate 70 may be constant or may vary. Preferably, the extrudate advancement rate 70 is constant and the same during the initial cutting and the secondary cutting steps. The cutting system may include one or more ultrasonic transducers 92. The one or more ultrasonic transducers 92 may be part of the ultrasonic knife, attached to the ultrasonic knife, or otherwise connected to the ultrasonic knife so that the ultrasonic vibration of the knife is controlled by the transducer 92.

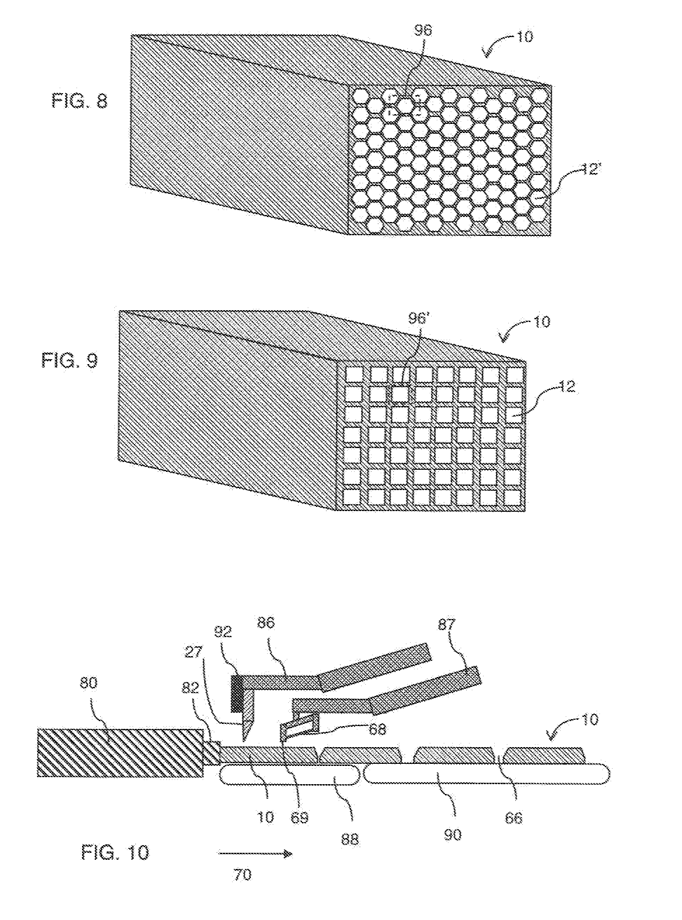

The devices, apparatus, systems, and methods according to the teachings herein may be employed in cutting an extrudate having a cross-section that is solid or a cross-section having one or more cells. Particular benefits are obtained when the cross-section includes one or more cells. Generally a cell will extend the length of the extrudate. Cutting of extrudates having a large number of cells may be accomplished using the devices, apparatuses, systems, and methods according to the teachings herein. For example the extrudate may have about 2 or more, about 6 or more, about 12 or more, about 20 or more, about 30 or more, or about 80 or more cells. The cells may be arranged in a regular pattern or may be irregularly arranged. For example, the cells may be arranged in an array including one or more rows, and one or more columns. The number of rows preferably is 2 or more, 4 or more, or 7 or more. The number of columns preferably is 2 or more, 4 or more, or 7 or more. The repeating pattern may include any number of cells. For example, the cross-section in FIG. 8 illustrates a repeating pattern 96 with 2 cells, and the cross section in FIG. 9 illustrates a repeating pattern 96′ with 1 cell.

The extrudate preferably is characterized as having a plurality of cells including a first row of cells near the bottom of the extrudate and a top row of cells near the top of the extrudate. For example, the extrudate may have three or more rows of open cells including an uppermost row of open cells and a top outer wall above the uppermost row of open cells. During a precut step, it is preferred that the ultrasonic knife cut through the entirety of the top outer wall so that the uppermost row of open cells is exposed;

The extrudate structure may be a generally honeycomb structure such as the structure having generally hexagonally shaped cells as illustrated in FIG. 8. The extrudate structure may have an array of generally rectangular or square shaped cells, such as illustrated in FIG. 9. It will be appreciated that the spacing between cells may be generally uniform. However, irregularly spaced cells may also be employed.

The extrudate may have one or more outer surfaces that are arcutate, one or more surfaces that are flat, or both. If the part has a bottom surface that is arcuate, a carrier may be employed for conveying or otherwise parrying the part. The extrudate structure preferably has a generally flat bottom so that the extrudate can be conveyed along a flat conveyor belt. The shape of the cross-section (i.e., the outer perimeter of the cross-section) of the honeycomb structure perpendicular to the machine direction may have two or more sides, three or more sides, or four or more sides. For example the shape may be a triangle, a square, a rectangle, a pentagon, a hexagon, a semi-circle, or a semi-oval, a semi-ellipse. Preferably, the honeycomb structure has a generally uniform cross-section with an outer perimeter that is generally polygonal, and more preferably generally rectangular.

The devices, apparatuses, systems, and methods according to the teachings herein may be employed with any extruded material. Particular advantages are found when cutting through materials that are in a formable state. The material may be an organic material, an inorganic material, or both. The material may include polymeric material or may be substantially free of polymeric material. The extrudate material (i.e., the extrudate composition) may be a mixture including one or more particulate materials and one or more liquid materials.

A particularly preferred extrudate material is ay material that includes, consists essentially of, or consists entirely of one or more inorganic compounds. For example, the extrudate may include particles of one or more inorganic compounds. The extrudate may include a sufficient amount of one or more binders for holding the particles together, for improving the flow of the material, or both. The binder may include one or more liquids suitable for holding the particles together, suitable for improving the flow of the material, or both. A particularly preferred liquid for the extrudate material is a liquid that includes, consists essentially of, or consists of water, glycol ether, or both. Examples of inorganic particles that may be employed include particles including silicon atoms, aluminum atoms, titanium atoms, or any combination thereof. The particles may include or consist of one or more inorganic oxides. For example, the particles may include a silicon oxide, an aluminum oxide, a titanium oxide, or any combination thereof. Particularly preferred inorganic compounds include about 35 atomic % or more oxygen atoms. For example about 35 percent or more of the atoms in the extrudate material may be oxygen atoms. The extrudate material may include one or more clays and one or more binders. If employed, the concentration of the clay preferably is about 20 weight percent or more, more preferably about 40 weight percent or more, based on the total weight of the extrudate material.

Preferred inorganic particles have an average size of about 100 μm or less, more preferably about 30 μm or less, even more preferably about 10 μm or less, and most preferably about 5 μm or less. Typically the inorganic particles have an average size of about 0.01 μm or more.

The amount of liquid in the extrudate material may be sufficient so that the extrudate material can be processed through an extruder and through an extruder die at or near ambient temperatures. For example the extrusion temperature, the temperature of the material going through the die, or both may be about 38° C. or less, about 35° C. or less, about 30° C. or less, or about 25° C. or less. The extrusion temperature, the temperature of the material going through the die, or both may be about 5° C. or more, more preferably about 10° C. or more.

The extrudate material may be capable of being dried or baked so that the extrudated material is no longer formable.

In order for the extrudate material to be formable, it may include one or more binders. The binder may include, consist essentially of, or consist entirely of one or more low molecular weight fluid. By way of example, the binder may include, consist essentially of, or consist entirely of water, a solvent, a plasticizer, or any combination thereof. The concentration of the low molecular weight fluid should be sufficiently high so that the material is formable. For example, the concentration of the low molecular weight fluid may be about 1% or more, about 2% or more, about 4% or more, about 6% or more, about 8% or more, or about 10% or more. The concentration of low molecular weight fluid preferably is sufficiently low so that the part does not flow without an applied force. For example, the concentration of the low molecular weight fluid may be about 40% or less, about 30% or less, about 25% or less, about 20% or less, based on the total weight of the material.

The extrudate material may be include one or more ceramic precursors. An extruded part including a ceramic precursor may be used for a producing a ceramic filter. For example, the extrudate material may be used for producing a ceramic filter suitable for filtering diesel particles (i.e., a diesel particle filter). The extrudate material including one or more ceramic precursors optionally include: one or more binders, one or more liquid carriers, or both. The ceramic precursors are the reactants or components which when exposed to certain conditions form a ceramic body or part from a formable extrudate part (e.g., a wet ceramic greenware bodies). Any known ceramic precursors may be utilized in the formation of a wet ceramic greenware bodies and ultimately the ceramic filter. Included in ceramic precursors are the precursors utilized to prepare one or more of mullite (such as disclosed in U.S. Pat. No. 7,485,594; U.S. Pat. No. 6,953,554; U.S. Pat. No. 4,948,766 and U.S. Pat. No. 5,173,349 all incorporated herein by reference), silicon carbide, cordierite, aluminum titanate, alumina, zirconia, silicon nitride, aluminum nitride, silicon oxynitride, silicon carbonitride, beta spodumene, strontium aluminum silicates, lithium aluminum silicates, and the like. Preferred porous ceramic bodies include mullite, silicon carbide, aluminum titanate, cordierite, and compositions containing ceramind binders and ceramic fibers, mullite or combination thereof. Preferred silicon carbides are described in U.S. Pat. Nos. 6,582,796, 6,669,751B1 and WO Publications EP1142619A1, WO 2002/070106A1. Other suitable porous bodies are described by WO 2004/011386A1, WO 2004/011124A1, US 2004/0020359A1 and WO 2003/051488A1, all incorporated herein by reference. Organic binders useful in this invention include any known materials which render the wet ceramic precursor mixture shapeable. Preferably, the binders are organic materials that decompose or burn at temperatures below the temperature wherein the ceramic precursors react to form ceramic filter segments. Among preferred binders are those described in Introduction to the Principles of Ceramic Processing, J. Reed, Wiley Interscience, 1988) incorporated herein by reference. A particularly preferred binder is methyl cellulose (such as METHOCEL A15LV methyl cellulose, The Dow Chemical Co., Midland, Mich.). Liquid carriers include any liquid that facilitates formation of a shapeable wet ceramic mixture. Among preferred liquid carriers (dispersants) are those materials described in Introduction to the Principles of Ceramic Processing, J. Reed, Wiley Interscience, 1988). A particularly preferred liquid carrier is water. The mixture useful in preparing wet ceramic greenware bodies may be made by any suitable method such as those known in the art. Examples include ball milling, ribbon blending, vertical screw mixing, V-blending and attrition milling. The mixture may be prepared dry (i.e., in the absence of a liquid carrier) or wet. Where the mixture is prepared in the absence of a liquid carrier, a liquid carrier is added subsequently utilizing any of the methods described in this paragraph.

The mixture of ceramic precursors, optionally binders, and liquid carriers may be shaped by any means known in the art. Examples include injection molding, extrusion, isostatic pressing, slip casting, roll compaction and tape casting. Each of these is described in more detail in Introduction to the Principles of Ceramic Processing, J. Reed, Chapters 20 and 21, Wiley Interscience, 1988, incorporated herein by reference. In a preferred embodiment the mixture is shaped into the near net shape and size of the ultimate desired ceramic part. Near net shape and size means the size of the wet ceramic greenware body is within 10 percent by volume of the size of the final ceramic filter, and preferably the size and shape is within 5 percent by volume of the size of the final ceramic filter. In a preferred embodiment, the wet ceramic greenware body is shaped such that it can be utilized as a flow through filter. At this stage in the process the wet ceramic greenware body has two opposing faces which are substantially planar. The wet ceramic filter greenware body exhibits a cross sectional shape which is consistent for all planes parallel to the two opposing faces. Preferably, at this stage, all of the flow passages are open to both opposing faces. This allows more efficient removal of liquid carrier.

The process for cutting an extrudate material according to the teachings herein preferably includes a pre-cut step and a final cut step using different cutting tools. During the pre-cut step, generally only a portion of the height of the extrudate is cut. The process may include a step of pre-cutting the extrudate using an ultrasonic blade. The process may include a step of making a final cut in the extrudate using a wire cutter. For example, the process may include a step of cutting the extrudate with a wire so that an extruded part having a predetermined length is formed.

The process may include a step of cutting an extrudate having a plurality of rows of open cells including an uppermost row of open cells, and a top outer wall above the uppermost row of open cells. Preferably, the process includes a step of making a precut through at least the top outer wall.

The process may be characterized by one or any combination of the following features: the process may include a step of forming a profile by passing the extrudate material (e.g., a mixture) through a die; the process may includes a step of conveying the extrudate away from the die using a conveyor in the extrusion direction; the step of precutting the extrudate may include synchronously moving the ultrasonic knife and the extrudate in the extrusion direction while cutting the extrudate by moving the ultrasonic knife in a direction perpendicular to the extrusion direction; or the process may include a step of removing inorganic material from a surface of the knife by moving the knife to a liquid bath (or moving a liquid bath to the knife) and vibrating the knife in the water.

The step of precutting the extrudate material preferably includes a step of using an ultrasonic knife for making a pre-cut in an extrudate material that includes, consists essentially of, or consists entirely of one or more inorganic compounds.

The step of pre-cutting the extrudate material may include cutting an extrudate having three or more rows of open cells including an uppermost row of open cells and a top outer wall above the uppermost row of open calls, wherein the step-of precutting the extrudate includes cutting entirely through the top outer wall so that the uppermost row of open cells is exposed.

During the pre-cut step, during the removal of the ultrasonic blade from the pre-cut, or both, the ultrasonic knife preferably travels faster in the extrusion direction (i.e., the travel direction of the extrudate) relative to the extrudate so that only the front surface of the knife contacts the extrudate.

Following the pre-cut and the final cut, preferably all of the cells of the part remain open. Following the pre-cut and the final cut, preferably all of the cells of the extrudate trailing the part remain open.

### EXAMPLES

### Example 1

A material including a mixture of inorganic particles and water is extruded at room temperature. The material passes through a die to produce a profile including about 1936 generally square cells arranged in an array of about 44 rows by about 44 columns. The profile has a height of about 80 mm and a width of about 80.2 mm. The tolerance for the part height is about ±4 mm. The extrudate is conveyed on a conveyor at a constant speed. The extrudate is cut using a wire cutter while the material is still formable and prior to drying the material. The wire cutter advances synchronously with the extruded part during the cutting. The wire cutter deforms the profile so that one or more of the cells is blocked or otherwise sealed on the trailing side of the wire cutter (i.e., towards the extruder). A vaccum is formed in the blocked cell as the material continues to advance from the extruder. The extrudate collapse so that the height of the part is no longer within the tolerance.

### Example 2

The process of example 1 is repeated except the extrudate is first pre-cut using an ultrasonic knife. The ultrasonic knife travels at a speed synchronous with or greater than the speed of the extrudate. The ultrasonic knife makes a pre-cut through only the top 1-4 rows of cells and then the ultrasonic knife is removed. The cut through the remainder of the cross-section is made using a wire cutter that travels away from the extruder synchronously with the extrudate. None of the cells become blocked or sealed and no vacuum is formed. The extrudate maintains its height within about 1 mm.

1. An apparatus for cutting an extrudate comprising:
an ultrasonic knife that vibrates at one or more frequencies for making one or more precuts into an extrudate; and
one or more wire cutters for making a final cut into the extrudate;
so that an extruded part having a predetermined length may be cut from the extrudate.

2. The apparatus of claim 1, wherein the ultrasonic knife has a blade with a tapered tip.

3. The apparatus of claim 1, wherein the apparatus includes a water bath for ultrasonically cleaning the knife.

4. The apparatus of claim 1, wherein the extrudate has a plurality of cells including a first row of cells near the bottom of the extrudate and a top row of cells near the top of the extrudate.

5. The apparatus of claim 1, wherein the apparatus includes:
an extruder for extruding the extrudate;
a die for forming a profile for the extrudate; and
a conveyor for conveying the extrudate away from the die in the horizontal direction;
wherein during the cutting the ultrasonic knife travels in the horizontal direction generally
synchronously with the conveyor.

6. The apparatus of claim 1, wherein the ultrasonic knife has a vibration frequency of about 13 kHz or more.

7. The apparatus of claim 1, wherein the ultrasonic knife has a surface that includes titanium.

8. The apparatus of claim 1, wherein the wire cutter has a diameter of about 0.5 mm or less.

9. The apparatus of claim 1, wherein the apparatus includes a die capable of producing a profile having 3 or more rows of cells.

10. (canceled)

11. A process for cutting an extrudate comprising:
a step of precutting the extrudate using an ultrasonic knife, wherein the extrudate includes one or more inorganic compounds.

12. The process of claim 11, wherein the process includes:
a step of cutting the extrudate with a wire so that an extruded part having a predetermined length is formed.

13. The process of claim 11, wherein the extrudate has a plurality of rows of open cells including an uppermost row of open cells, and a top outer wall above the uppermost row of open cells, wherein the precut cuts through the top outer wall.

14. (canceled)

15. The process of any of claim 11, wherein the process includes one or any combination of the following:
i. the process includes a step of extruding at least some of a mixture including one or more inorganic compounds through an extruder;
ii. the process includes a step of forming a profile passing at least some of the mixture through a die;
iii. the process includes a step of conveying the extrudate away from the die using a conveyor in the extrusion direction;
iv. the step of precutting the extrudate includes synchronously moving the ultrasonic knife and the extrudate in the extrusion direction while cutting the extrudate by moving the ultrasonic knife in a direction perpendicular to the extrusion direction;
v. the process includes a step of removing inorganic material from a surface of the knife by moving the knife to a water bath and vibrating the knife in the water;
vi. the extrudate includes clay;
vii. the extrudate has three or more rows of open cells including an uppermost row of open cells and a top outer wall above the uppermost row of open cells, wherein the step of precutting the extrudate includes cutting entirely through the top outer wall so that the uppermost row of open cells is exposed;
viii. the ultrasonic knife has a frequency of about 15 kHz or more;
ix. the wire cutter travels and the extrudated travel synchronously during the step of final cutting of the extrudate with the wire cutter, and the wire cutter has a diameter of about 0.5 mm or less;
x. the ultrasonic knife includes a blade having a tapered tip for cutting; or
xi. any combination of i through x.

16. The process of claim 15, where the process includes i through x.

17. The process of claim 15, wherein process includes a step of removing the ultrasonic knife from the extrudate, wherein the ultrasonic knife travels faster in the extrusion direction relative to the extrudate so that only the front of the knife contacts the extrudate while removing the ultrasonic knife from the extrudate.

18. The process of claim 15, wherein the extrudate has a generally rectangular profile with a width and height and the blade has a cutting edge having a length that is greater than the length of the width of the profile.

19. The process of claim 15, wherein all of the cells of the part remain open after cutting the profile.

20. The process of claim 15, wherein all of the cells of the extrudate trailing the part remain open after cutting the profile.

21. (canceled)
